(19) United States
(12) Patent Application Publication
(10) Pub. No.: US 2009/0024722 A1
(43) Pub. Date: Jan. 22, 2009

(54) PROXYING AVAILABILITY INDICATIONS IN A FAILOVER CONFIGURATION

(75) Inventors: Radhakrishnan Sethuraman, Austin, TX (US); Manuel Silveyra, Round Rock, TX (US)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 11/778,881

(22) Filed: Jul. 17, 2007

(51) Int. Cl. G06F 15/177

(52) U.S. Cl. 709/220

(57) ABSTRACT

Under high load conditions, an intermediate network, element can act as a proxy for a primary network element and transmit availability indications for a heavily loaded primary network element. When the primary network element fails to provide an availability indication to one or more backup network, elements, an intermediate network element generates the availability indications and transmits them to the one or more backups. Generating and transmitting availability indications from an intermediate network element for an active primary network element avoids false failover and avoid dedication of a network interface solely for availability indications.

### BACKGROUND

1. Field of the Invention

The invention generally relates to the field of computer networks, and, more particularly, to high availability computing.

2. Description of the Related Art

For high availability computing, a failover configuration designates a primary server and a secondary server. The primary server provides data and services requests from client while state of the primary server is replicated to the secondary server. The primary server transmits heartbeats to the secondary server to indicate that die primary server is still active. If the secondary server does not receive a heartbeat as expected, then failover is initiated and the secondary server assumes the duties of the primary server. Under heavy load conditions, a primary server may not be able to provide a heartbeat within the required period of time because the primary server is processing requests. Even though the primary server is still active and servicing requests from clients, a failover is initiated unnecessarily. To avoid false failovers, a network interface at the primary server is dedicated to delivering these heartbeats.

### SUMMARY

A method comprising monitoring traffic of a first network element to determine if a high load condition exists for the first network element. The network includes the first network element and a second network element in a failover configuration. The first network element operates as a primary network element and the second network element operates as a backup to the first network element. Data transmitted from the first network element is monitored by an intermediate network element to determine if the first network element is transmitting availability indications to the second network element prior to expiration of a given interval. If the high load condition exists for the first network element and the first network element fails to transmit an availability indication to the second network element before expiration of the given interval, then an availability indication is generated at the intermediate network element for the first network element. The intermediate network element transmits the generated availability indication to the second network element for the first network element.

### BRIEF DESCRIPTION OF THE DRAWINGS

Embodiments may be better understood, and its numerous objects, features, and advantages made apparent to those skilled in the art by referencing the accompanying drawings.

FIG. 1 depicts an example exchange between network elements in a failover configuration with an intermediate network element operating as a proxy.

FIG. 2 depicts an example proxying intermediate network element in a failover configuration that mirrors responses to the secondary server.

FIGS. 3A-3B depict a flowchart of example operations for proxying in a failover configuration. FIG. 3A depicts a flowchart of example operations for sampling data to detect a high load condition for proxying. FIG. 3B depicts a flowchart of example operations that continue from FIG. 3A.

FIG. 4 depicts an example computer system.

FIG. 5 depicts an example line card with functionality for proxying availability indications.

### DESCRIPTION OF EMBODIMENT

The description that follows includes exemplary systems, methods, techniques, instruction sequences and computer program products that embody techniques of the present invention. However, it is understood that the described invention may be practiced without these specific details. In other instances, well-known instruction instances, protocols, structures and techniques have not been shown in detail in order not to obfuscate the description.

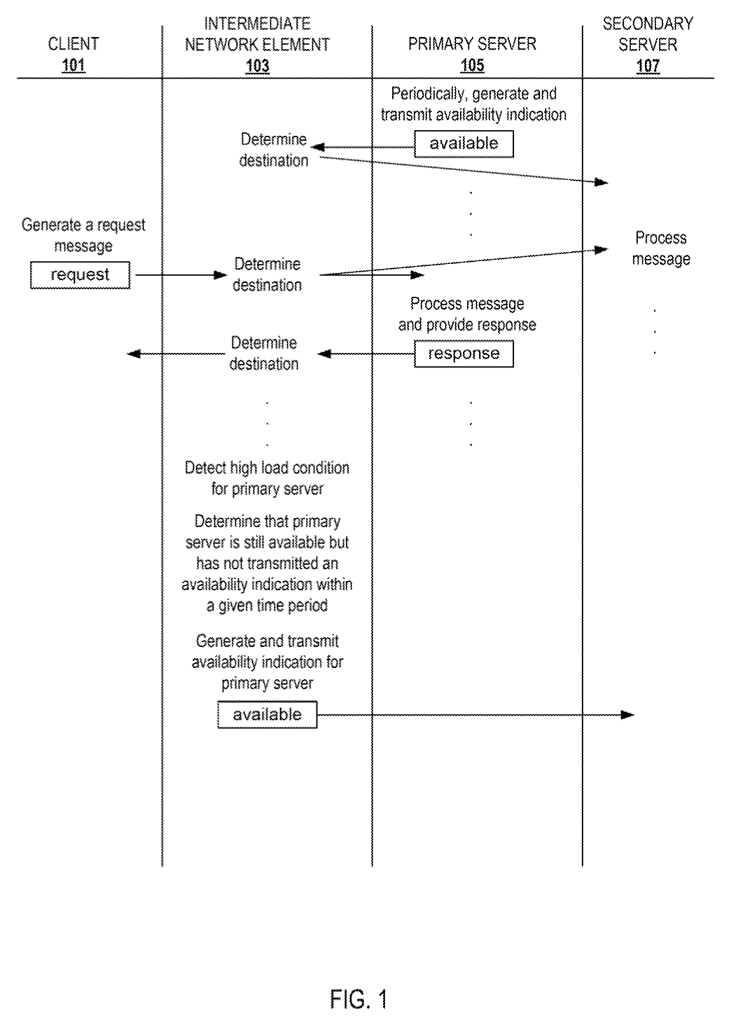

FIG. 1 depicts an example exchange between network elements in a failover configuration with an intermediate network element operating as a proxy. A network includes a primary server 105, a secondary server 107, and an intermediate network element 103 in a failover configuration. The intermediate network element 103 handles traffic in network. Examples of the intermediate network element 103 include a router, bridge, etc. After designation of the primary server 105 and the secondary server 107, the primary server 105 begins periodically generating an availability indication (e.g., heartbeat, keep alive message, etc.). The primary server 105 transmits the availability indication to the secondary server 107 via the intermediate network element 103. At a later time, a client 101 generates a request messages (e.g., an HTTP request, an SQL query, etc.), and transmits the request message to the primary server 105 via the intermediate network element 103. When the intermediate network, element 103 receives the request message, the intermediate network element sends the request message to both the primary server 105 and the secondary server 107. The primary server 105 and the secondary server 107 process the messages, thus maintaining consistent states between the primary server 105 and the secondary server. The primary server 105, however, provides a response to the client 101 via the intermediate network element 103.

At some point, the intermediate network element 103 detects a high load condition for the primary server 105. For instance, the intermediate network element 103 determines that the primary server 105 is receiving a certain amount of traffic, that the primary server 105 has a greater response time, etc. The intermediate network element 103 also determines that the primary server 105 does not provide an availability indication within a given time period to the secondary server 107, even though the primary server 105 is still active or alive. To avoid a false failover, the intermediate network element 103 acts as a proxy for the primary server 105 and generates an availability indication for the primary server 105. The intermediate network element 103 transmits the proxy availability indication to the second server 107.

Avoiding a false failover avoids the costs associated with a false failover. When a false failover occurs, the primary server is erroneously marked as dead and no longer used. In addition, resources will be mistakenly allocated to servicing the server now marked as erroneously dead. Further, employing an intermediate network element as a proxy for the primary server also allows the cost of a dedicated interface to be avoided. The additional network interface and corresponding bandwidth can be employed for data transfers instead of being entirely dedicated to availability indications.

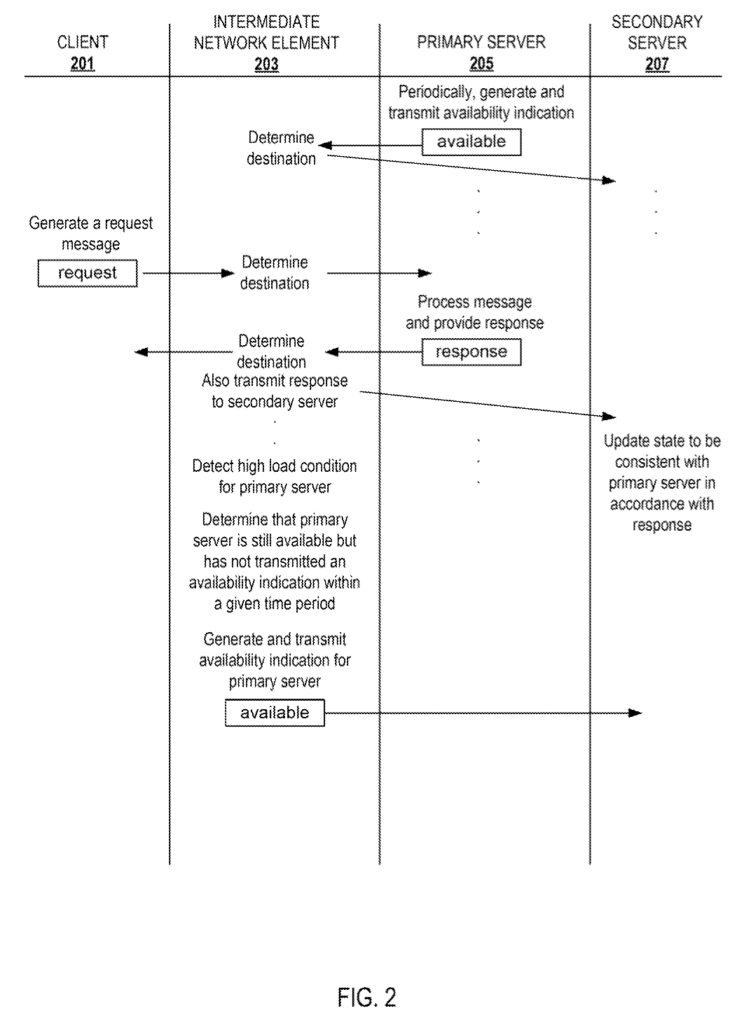

Although FIG. 1 depicts backup being implemented by performing processing on both the primary and the secondary servers, backup of state or data can be implemented in accordance with other techniques. FIG. 2 depicts an example proxying intermediate network element in a failover configuration that mirrors responses to the secondary server, hi FIG. 2, a network includes an intermediate network element 203, a primary server 205, and a secondary server 207. As in FIG. 1, the primary server 205 periodically generates and transmits availability indications to the secondary server 207 via the intermediate network element 203. In FIG. 2, when a request from a client 201 destined for the primary server 205 is received at the intermediate network element 203, the intermediate network element 203 transmits the request message to the primary server 205. When the intermediate network element 203 receives a response to the request message, the response message is mirrored to the secondary server 207. When the intermediate network element 203 detects a high load condition and detects that the primary server 205 does not transmit an availability indication to the secondary server 207 when expected, the intermediate network element 203 acts as a proxy. The intermediate network element 203 generates and transmits an availability indication for the primary server 203 to the secondary server 207.

The examples illustrated in FIGS. 1 and 2 are not intended to limit embodiments to failover configurations with a single backup. Embodiments include a failover configuration with N backups for a primary, in an N>1 failover configuration, availability indications are multicast to the N backups. Likewise, the proxy availability indication is multicast to the N backups.

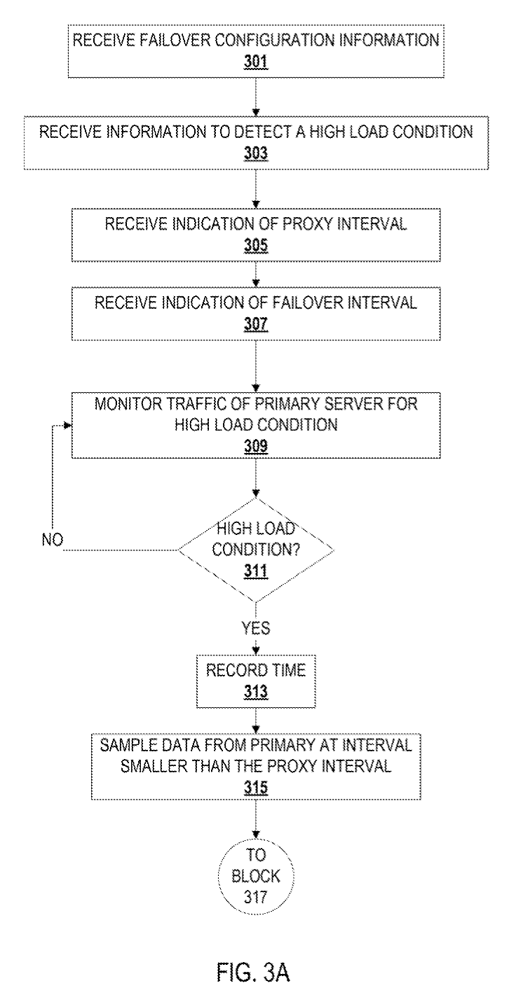

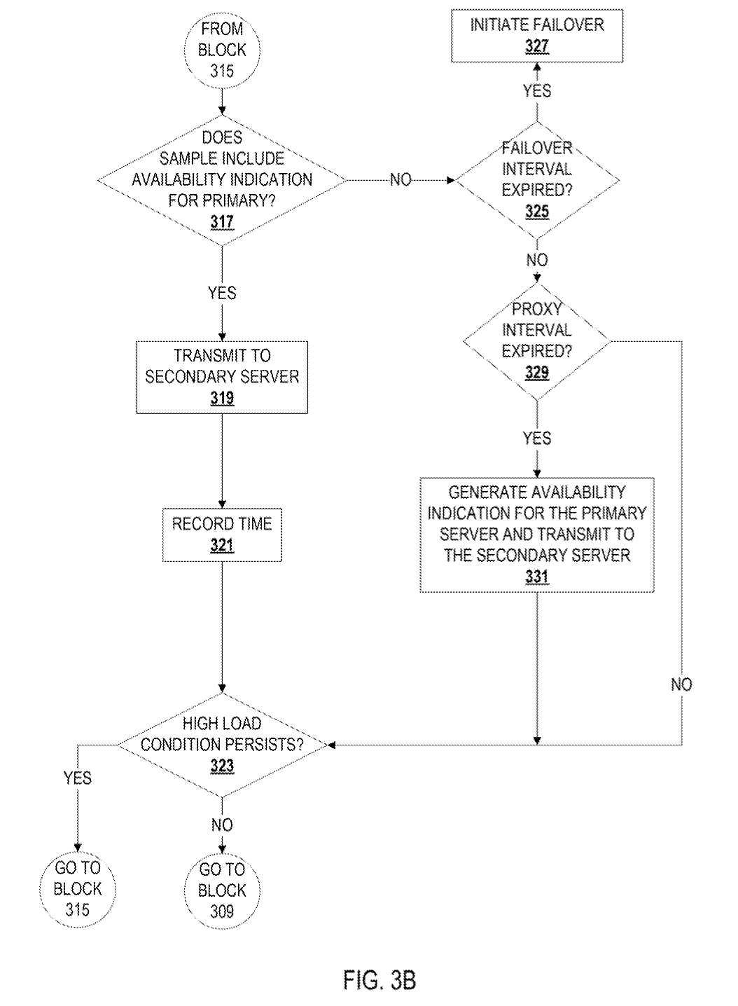

FIGS. 3A-3B depict a flowchart of example operations for proxying in a failover configuration. FIG. 3A depicts a flowchart of example operations for sampling data to detect a high load condition for proxying. At block 301 failover configuration information is received. For example, a user configures, remote or directly, through an interface (e.g., a command line interface, a graphical user interface, etc.) failover information that identifies a primary network element (e.g., data source or server) and one or more backup network elements. At block 303, information to detect a high load condition is received. For example, the information may indicate a peak stress level, threshold for traffic, etc. At block 305, an indication of a proxy interval is received. Upon expiration of the proxy interval the intermediate network element generates proxy availability indications. At block 307, an indication of a failover interval is received. Expiration of the failover interval causes the intermediate network element to consider the primary as dead. Possible metrics for the intervals include time, number of packets, number of bytes transmitted, etc.

At block 309, traffic of the primary server is monitored for a high load condition (e.g., peak stress level, heavy traffic, etc.). At block 311, it is determined if a high load condition exists. If a high load condition exists, then control flows to block 313. If a high load condition does not exist, then control flows to block 309.

At block 313, a time is recorded. The recorded time may be when, the high load condition is determined, a timestamp in a most recently received packet from the primary, etc. At block 315, data transmitted from the primary is sampled at a rate smaller than the proxy interval. For example, if the proxy interval is 5 seconds, then data transmitted from the primary is sampled by the intermediate network element every second. Control flow from block 315 to block 317.

FIG. 3B depicts a flowchart of example operations that continue from FIG. 3A. At block 317, it is determined if a sample includes an availability indication for the primary. If not, then control flows to block 325. If the sample includes the availability indication, then control flows to block 319. Various techniques can be employed for the intermediate network element to examine data from the primary network element and determine whether a sample includes an availability indication. A field in the header of a packet, frame or cell may represent the availability indication. The intermediate network element examines the header for the field, in another implementation, the availability indication occurs in a higher layer, such as the application layer.

At block 319, the sample is transmitted to the secondary network element. At block 321, a time is recorded to overwrite the previously recorded time. At block 323, it is determined if the high load condition persists. If the high load condition persists, then control flows to block 315. If the high load condition does not persist, then control flows to block 309.

At block 325, it is determined if the failover interval has expired based on the recorded time. If the failover interval has expired, then control flows to block 327. At block 327, failover is initiated. If the failover interval has not expired, then control flows to block 329. At block 329, it is determined if the proxy interval has expired.

If the proxy interval has not expired, then control flows to block 323. If the proxy interval has expired, then control flows to block 331. At block 331, the intermediate network element generates an availability indication for the primary network element and transmits the availability indication to the secondary network element. Control flows from block 331 to block 323.

The example operations depicted in FIG. 3 are for illustrative purposes and should not be used to limit embodiments of the invention. For example, blocks 305 and 307 may not be performed because default values indicate the intervals. As another example, an interval may not be employed to determine when the primary is dead, thus block 325 would not be performed. The intermediate network element may condition death of the primary network element on a lack of transmission for a given period of time from the primary. As another example, the blocks that record time may record a different metric used to determine expiration of the intervals, such as bytes transmitted.

The described embodiments may be provided as a computer program product, or software, that may include a machine-readable medium having stored thereon instructions, which may be used to program a computer system (or other electronic device(s)) to perform a process according to embodiments of the invention, whether presently described or not, since every conceivable variation is not enumerated, herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

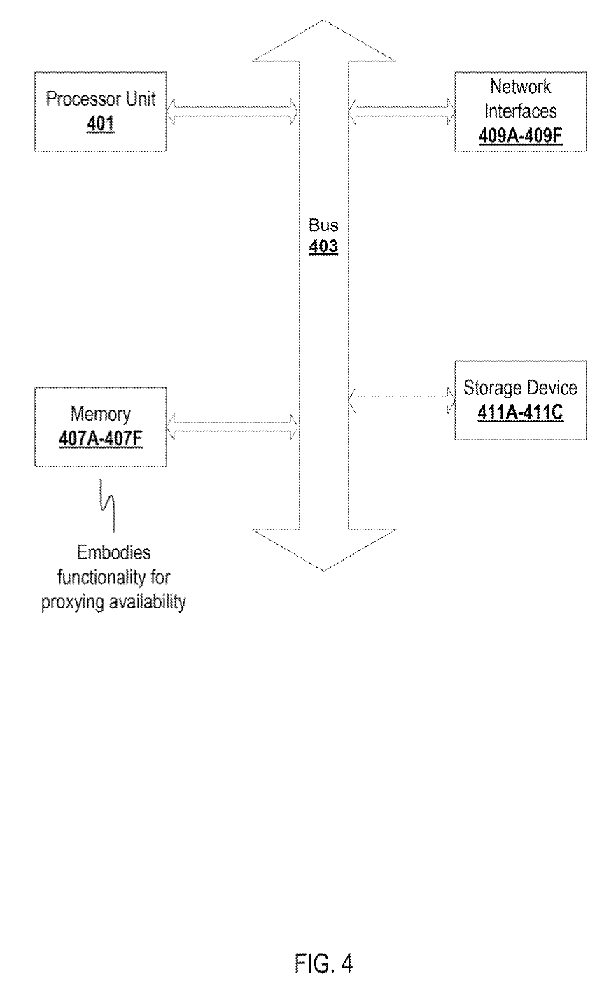

FIG. 4 depicts an example computer system. A computer system includes a processor unit 401 (possibly including multiple processors, multiple cores, multiple nodes, and/or implementing multi-threading, etc.). The computer system includes memory 407A-407F. The memory 407A-407F may be system memory (e.g., one or more of cache, SRAM. DRAM, RDRAM, EDO RAM, DDR RAM, EE PROM, etc.) or any one or more of the above already described possible realizations of machine-readable media. The computer system also includes a bus 403 (e.g., PCI, ISA, PCI-Express, HyperTransport, InfiniBand, NuBus, etc.), a network interface 405 (e.g., an ATM interface, an Ethernet interface, a TCP/IP interface, a Frame Relay interface, SONET interface, etc.), and a storage device(s) 409A-409D (e.g., optical storage, magnetic storage, etc.). The system memory 407A-407F embodies functionality for proxying available indications for a primary enduring a high load condition. Functionality for proxying availability indications may be partially (or entirely) implemented in hardware and/or on the processing unit 401. For example, the functionality may be implemented with an application specific integrated circuit, in logic in the processing unit 701, in a logic on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409A-409D, and the network interface 405 are coupled to the bus 403. The memory 407A-407F is coupled directly or indirectly to the bus 403.

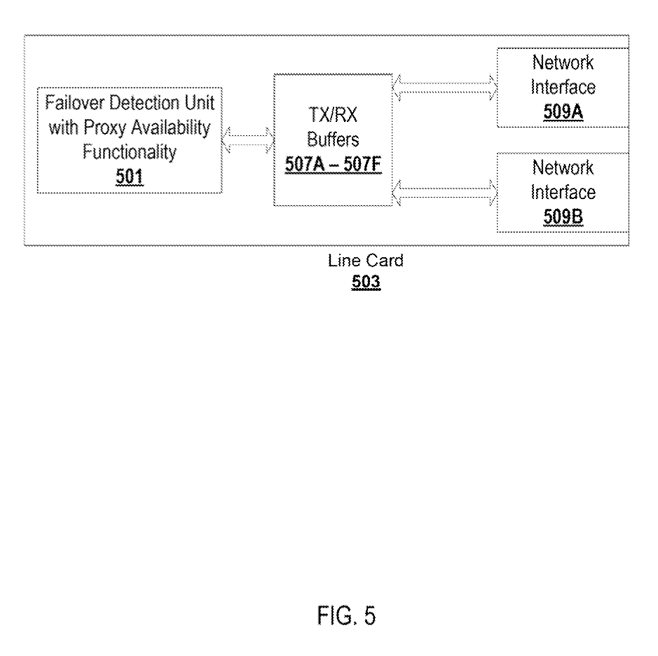

FIG. 5 depicts an example line card with functionality for proxying availability indications. An example line card 503 includes network interfaces 509A and 509B, transmit/receive buffers 507A-507F, and a failover detection unit 501. The failover detection unit 501 includes proxy availability functionality. Packets are received and transmitted over the network interfaces 509A and 509B. The packets are buffered for processing in the transmit/receive buffers 507A-507F. The failover detection unit 501 samples packets in the buffers 507A-507F. The sample rate may be configured by a user, be predefined value, be a dynamic value that adjusts to the rate of traffic, etc. The failover unit examines the samples for availability indications to determine whether the failover unit (or another unit) is to generate a proxy availability indication for a primary network element. The failover detection unit 501 may be implemented entirely in hardware, embodied as software in a processor unit of the line card 503, as a combination of hardware and software, etc.

### Other Embodiments

While the invention(s) is (are) described with reference to various implementations and exploitations, it will be understood that these embodiments are illustrative and that the scope of the invention(s) is not limited to them. In general, techniques for proxying availability in a failover configuration described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventions). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventions).

What is claimed is:

1. A method comprising:
monitoring traffic of a first network element to determine if a high load condition exists for the first network element, wherein a network includes the first network element and a second network element in a failover configuration, wherein the first network element operates as a primary network element and the second network element operates as a backup to the first network element;
monitoring data transmitted from the first network element to determine if the first network element is transmitting availability indications to the second network element prior to expiration of a given interval, wherein the monitoring is performed at an intermediate network element;
if the high load condition exists for the first network element and the first network element fails to transmit an availability indication to the second network element before expiration of the given interval, then generating an availability indication at the intermediate network element for the first network element and transmitting the generated availability indication to the second network element for the first network element.

2. The method of claim 1 further comprising:
determining if the first network element transmits the availability indication before expiration of a second interval; and
marking the first network element as dead if the first network element fails to transmit the availability indication before expiration of the second interval.

3. The method of claim 1, wherein the monitoring the data transmitted from the first network: element comprises:
sampling the data transmitted from the first network element at an interval less than the given interval.

4. The method of claim 1 further comprising transmitting the generated availability indication to a set of one or more additional network elements that also operate as backups to the first network element.

5. The method of claim 1, wherein the high bad condition is selected from a set consisting essentially of a peak stress level condition and heavy traffic condition.

6. The method of claim 1, wherein the given interval is measured with a metric selected from a set consisting essentially of time and data size.

7. The method of claim 1, wherein the monitoring the data transmitted from the first network element comprises examining fields in a header for a flag that represents the availability indication.

8. The method of claim 1, wherein the monitoring the data transmitted from the first network element comprises examining the data at an application layer.

9. A machine-readable medium encoded with instructions executable by a set of one or more processor units to cause the set of one or more processor units to perform operations that comprise:
monitoring traffic of a first network element to determine if a high load condition exists for the first network element, wherein the first network element and a second network element are in a failover configuration in a network and the second network elements operates as a backup to the first network element;
monitoring data transmitted from the first network element to determine if the first network element has transmitted an availability indication to the second network element prior to expiration of a given interval;
if the high load condition exists for the first network element and the first network element fails to transmit an availability indication to the second network element before expiration of the given interval, then generating a proxy availability indication for the first network element and transmitting tire generated proxy availability indication to the second network element for the first network element.

10. The machine-readable medium of claim 9, wherein the operations further comprise:
determining if the first network element transmits the availability indication before expiration of a second interval; and
indicating the first network element as dead if the first network element fails to transmit the availability indication before expiration of the second interval.

11. The machine-readable medium of claim 9, wherein the operation of monitoring the data transmitted from the first network element comprises:
sampling the data transmitted from the first network element at an interval less than the given interval.

12. The machine-readable medium of claim 9, wherein the operations further comprise transmitting the generated availability indication to a set of one or more additional network elements that also operate as backups to the first network element.

13. The machine-readable medium of claim 9, wherein the high load condition is selected from a set consisting essentially of a peak stress level condition and a heavy traffic condition.

14. The machine-readable medium of claim 9, wherein the given interval is measured with a metric selected from a set consisting essentially of time and data size.

15. The machine-readable medium of claim 9, wherein the operation of monitoring the data transmitted from the first network element comprises examining fields in a header for a flag that represents the availability indication.

16. The machine-readable medium of claim 9, wherein the operation of monitoring the data transmitted from the first network element comprises examining the data at an application layer.

17. An intermediate network element comprising:
a plurality of network interfaces operable to transmit and to receive data;
a set of one or more processor units; and
a failover detection unit coupled with the plurality of network interfaces and the set of one or more processor units, the failover detection unit operable to detect a high load condition for a primary network element and operable to detect if the primary network element is available over at least one of the plurality of network interfaces, the failover detection unit operable to generate and to transmit availability indications for the primary network element to a backup network element when the failover detection unit detects the high load condition for the primary network element and detects that the primary network element fails to transmit an availability indication to the backup network element before expiration of a given interval.

18. The intermediate network element of claim 17 further comprising a plurality of transmit and receive buffers.

19. The intermediate network element of claim 17, wherein the failover detection unit is further operable to sample data transmitted from the first network element at an interval smaller than the given interval, and operable to example sampled data for availability indications.

20. The intermediate network element of claim 17, wherein the failure detection unit is further operable to multicast the availability indication generated for the primary network element to a set of one or more additional backup network elements.
